(19) United States
(12) Patent Application Publication
(10) Pub. No.: US 2008/0269041 A1
(43) Pub. Date: Oct. 30, 2008

(54) Crucible for melting high chromium alloys

(75) Inventor: Alfred P. Kaulius, Muskegon, MI (US)

Correspondence Address: Mr. Edward J. Timmer, P.O. Box 770, Richland, MI, 49083-0770, US

(73) Assignee: Howmet Corporation

(21) Appl. No.: 11/796,961

(22) Filed: Apr. 30, 2007

(51) Int. Cl. C04B 35/48

(52) U.S. Cl. 501/103

(57) ABSTRACT

A crucible material comprises in weight % as a dry particulates mixture, before sintering, about 89% to about 93% ZrO₂, about 7% to about 11% Y₂O₃, up to about 0.6% SiO₂ as an impurity element, and is substantially free of magnesia. The crucible can be used in the melting or holding of a high chromium sputtering target alloy to provide a low oxygen concentration of the melted alloy of 300 ppm by weight or less.

### FIELD OF THE INVENTION

The present invention relates to crucibles and methods for melting alloys containing high levels of chromium in a manner to provide oxygen concentration in the melted alloy at or below low concentrations set by specification of end-users.

### BACKGROUND OF THE INVENTION

Ceramic crucibles are known in the metal casting art for melting and/or holding a molten metal or alloy. An induction melting crucible typically includes a ceramic crucible around which an induction coil is disposed to heat and melt a solid metal or alloy charge. Holding or transfer crucibles are used to hold molten metal or alloy for a next operation, such as pouring, or to carry molten metal or alloy from one location to another.

High chromium sputtering target alloys, such as Cr—B alloys, Cr—Mn alloys, Cr—V alloys and the like, have been melted in the past in magnesia stabilized zirconia crucibles. For example, a representative magnesia stabilized zirconia crucible has been made from crucible material comprising, prior to sintering, monoclinic zirconia (ZrO₂) in an amount of about 95 weight %, magnesia (MgO) in an amount of about 3 weight %, and silica (SiO₂) in an amount of about 1.3 weight % of the mixture.

However, in melting high chromium sputtering target alloys of the type mentioned above using magnesia stabilized zirconia crucibles, the oxygen concentration of the alloys has been observed to increase outside an upper specification limit, such as 300 ppm by weight oxygen, set by target end-users where performance of the sputtering target is known to be adversely affected by higher oxygen concentration.

There is a need for a crucible material for making crucibles for use in melting and/or holding high chromium alloys to provide a low oxygen concentration within specification limits.

There also is a need for a method of melting and/or holding high chromium or other sputtering target alloys that provides a low oxygen concentration within specification levels.

### SUMMARY OF THE INVENTION

The present invention provides a yttria stabilized zirconia-based crucible material in a manner to satisfy the above needs.

In an illustrative embodiment of the invention, the crucible material comprises, before sintering or firing, a low silica, yttria stabilized zirconia-based ceramic material such that crucibles made from the material provide a desired low oxygen content of high chromium alloys melted and/or held in the crucibles.

In a preferred embodiment of the invention, the crucible material comprises, in weight % as a dry particulates mixture, before sintering or firing, about 89% to about 93% monoclinic ZrO₂, about 7 to about 11% Y₂O₃, and up to about 0.6% SiO₂ preferably present only as an impurity element. The crucible material is substantially free of magnesia such that magnesia is present in no more than 0.2 weight % of the material. Even more preferably magnesia is not present (0 weight %) in the mixture.

The present invention also provides in another illustrative embodiment a method for melting and/or holding a high chromium alloy or sputtering target alloy, wherein the alloy is melted and/or held in a yttria stabilized zirconia-based crucible to provide a low oxygen content of the alloy to specification levels of about 300 ppm by weight or below.

The above and other advantages of the present invention will become more readily apparent from the following drawings taken in conjunction with the following detailed description.

### DESCRIPTION OF THE INVENTION

The present invention provides a yttria stabilized zirconia-based crucible material that is especially useful for making crucibles for melting and/or holding high chromium alloys (chromium-based alloys) for use as sputtering targets. Such sputtering target alloys typically have Cr contents of about 50 weight % and above and have a metal or other alloying element such as B, Mn, V and the like present in an amount up to about 40 weight % of the alloy. The invention is especially useful, although not limited to, melting and/or holding high chromium sputtering target alloys or other sputtering target alloys where oxygen concentration of the alloy is controlled so as not to exceed a specified value. One particular sputtering target alloy comprises 97 weight % Cr and 3 weight % B for purposes of illustration and not limitation where oxygen is controlled to about 300 ppm by weight or below.

Pursuant to an illustrative embodiment of the invention, the crucible material comprises a low silica, yttria stabilized zirconia-based material such that crucibles made from the material provide a low oxygen content of high chromium alloys melted and/or held in the crucibles. The amount of any SiO₂ present and the substantial exclusion of MgO from the crucible material maintain and/or reduce oxygen enrichment of high chromium alloys melted and/or held in a sintered or fired crucible made of the material.

An exemplary crucible material comprises, in weight %, before sintering or firing, about 89% to about 93% monoclinic ZrO₂, about 7 to about 11% Y₂O₃, and up to about 0.6% SiO₂ preferably present only as an impurity element and not intentionally included in the crucible material. The crucible material is substantially free of magnesia in that magnesia is present in no more than 0.2 weight % of the material. Even more preferably magnesia is not present (0 weight %) in the material.

The ZrO₂ component typically may include a small amount of impurity HfO₂, such as 1.7 to 2.0 weight % HfO₂. The crucible material also may include impurity amounts of Al₂O₃, TiO₂ and/or CaO in individual amounts less than 0.5 weight %.

A particularly preferred crucible material comprises 89.1 weight % ZrO₂, 9.1 weight % Y₂O₃, and up to 0.1 weight % SiO₂ with no (0 weight %) Mgo present. The zirconia (ZrO₂) is present as ZrO₂ particles in a plurality of particle sizes wherein a majority of the ZrO₂ particles have a particle size of less than 200 mesh size (US Standard Seive).

In practicing the invention, the ZrO₂ particles and Y₂O₃ particles are dry mixed for a suitable time to form a homogenous dry mixture. A conventional V-Cone mixer available from Patterson-Kelly Co., or any other suitable dry mixer, can be used to this end.

The dry mixture then is mixed with a suitable binder comprising, for example, a controlled amount of water and a binding agent such as gum arabic, for a suitable time to form a homogenous wet mixture having a desired water content. For purposes of illustration and not limitation, the binder comprises 55 weight % gum arabic and balance water. The liquid binder can be present in an amount of 5 weight % of the wet mixture. A conventional MULLER mixer available from Simpson Co., or any other suitable mixer, can be used to mix the liquid binder and dry mixture to form the wet mixture.

The wet mixture then is passed through a vibratory SWECO separator 24 mesh (Tyler) screen (model No. 1S18S33 from Sweco, Inc. Los Angeles, Calif.) to remove agglomerates greater than 24 mesh (approximately 170 microns), permitting material finer than 24 mesh to pass through and be used for pressing. For purposes of illustration and not limitation, the moisture content of the wet mixture is within a selected range of 1.4 to 2.4 weight % water. The wet mixture then can be pressed using conventional molding equipment to form a free-standing green (unfired) crucible body shape.

The molded crucible body can be sintered (fired) at a high temperature above 1650 degrees C. in air, preferably in the range of 1660 to 1690 degrees C., to form a sintered (fired) crucible or lining, that is ready for use to melt a metal or alloy or to hold a molten metal or alloy. When the crucible material is sintered as described, the Y₂O₃ component is soluble in the ZrO₂ component.

A test crucible was made pursuant to an illustrative embodiment of the invention. For example, the following test crucible material expressed in weight percent of the dry particulate mixture were tested:

| ZrO₂ | | | |
|---|---|---|---|
| monoclinic | MgO | SiO₂ | Y₂O₃ |
| 90.9% | 0% | 0% | 9.1% |

The monoclinic ZrO₂ particles comprised 29 weight % of particles of 35/100 mesh size, 49 weight % of particles of 100/325 mesh size, and 21 weight % of particles less than 325 mesh size where 35/100 indicates that the particles are less than 35 and more than 100 mesh size and 100/325 indicates that the particles are less than 100 and more than 325 mesh size. Most of the Y₂O₃ particles (95 weight %) were less than 400 mesh size.

The ZrO₂ particles and the Y₂O₃ particles were dry mixed using a conventional V-Cone mixer for 30 minutes to form a homogenous dry mixture. The dry mixture then was mixed with a liquid binder (56 weight % gum arabic and balance water) for 45 minutes to form a homogenous wet mixture. The liquid binder comprised 5 weight % of the wet mixture. A conventional MULLER mixer was used. The wet mixture then was sieved to remove agglomerates as described above.

The wet mixture then was pressed in a conventional isopress molding machine to form a free-standing molded, green crucible comprising a right-cylinder with a closed end. The molded, green crucible body was sintered (fired) at a temperature of 1675 degrees C) in air for 120 minutes.

A high chromium sputtering target alloy (97 weight % Cr and 3 weight % B) was induction melted in test crucibles pursuant to this Example under vacuum of 340 torr and held in the crucible for 30-90 minutes before pouring into a mold.

The high chromium sputtering target alloy melted in the test crucibles exhibited an oxygen concentration within a specification maximum limit of 300 ppm by weight for oxygen of the melted alloy.

Although the invention is described above with respect to certain embodiments, those skilled in the art will appreciate that modifications and changes can be made therein without departing from the spirit and scope of the invention set forth in the appended claims.

I claim

1. A crucible material consisting essentially of, in weight %, before sintering or firing, about 89% to about 93% ZrO₂, about 7% to about 11% Y₂O₃, and up to about 0.6% SiO₂.

2. The material of claim 1 which is substantially free of magnesia.

3. The material of claim 2 wherein magnesia is not present and is 0 weight % of the mixture.

4. The material of claim 1 wherein SiO₂ is present only as an impurity.

5. A crucible material consisting essentially of, in weight %, before sintering or firing, about 89% to about 93% ZrO₂ and about 7% to about 11% Y₂O₃ with SiO₂ present only as an impurity and with the crucible material being substantially free of MgO.

6. A crucible made by shaping a crucible material into a crucible shape and sintering or firing the shape wherein the crucible material consists essentially of, in weight %, before sintering or firing, about 89% to about 93% ZrO₂, about 7% to about 11% Y₂O₃, and up to about 0.6% SiO₂.

7. In a method of melting or holding a chromium-based alloy, the improvement comprising melting or holding the alloy in the crucible of claim 6.

8. The method of claim 7 wherein the oxygen content of the alloy is about 300 ppm by weight or less.

9. The method of claim 7 wherein the alloy has a Cr content of 50 weight % or more.

10. In a method of melting or holding a sputtering target alloy wherein oxygen concentration is controlled, the improvement comprising melting or holding the alloy in the crucible of claim 6.

11. The method of claim 10 wherein the crucible material includes SiO₂ only as an impurity and wherein the crucible material is substantially free of MgO.
